(19) United States
(12) Patent Application Publication
(10) Pub. No.: US 2019/0332845 A1
(43) Pub. Date: Oct. 31, 2019

(54) ELECTRONIC DEVICE WITH FINGERPRINT VERIFICATION FUNCTION AND OPERATION METHOD THEREOF

(71) Applicants: Shu-Hsien Chu, Taipei City (TW); Wang-Hung Yeh, Taipei City (TW); Hsin-Chieh Fang, Taipei City (TW); Ching-Shiang Chang, Taipei City (TW)

(72) Inventors: Shu-Hsien Chu, Taipei City (TW); Wang-Hung Yeh, Taipei City (TW); Hsin-Chieh Fang, Taipei City (TW); Ching-Shiang Chang, Taipei City (TW)

(73) Assignee: COMPAL ELECTRONICS, INC., Taipei City (TW)

(21) Appl. No.: 16/395,228

(22) Filed: Apr. 25, 2019

Related U.S. Application Data
(60) Provisional application No. 62/663,226, filed on Apr. 26, 2018.

(51) Int. Cl. G06K 9/00; G07C 9/00; G06F 21/32; G06F 3/0487

(52) U.S. Cl. CPC G06K 9/00006; G06F 3/0487; G06F 21/32; G07C 9/00158

(57) ABSTRACT

An electronic device with a fingerprint verification function and an operation method thereof are provided. The electronic device includes a first fingerprint sensor and a second fingerprint sensor. The first fingerprint sensor is configured to verify a first fingerprint. The second fingerprint sensor is configured to verify a second fingerprint. When one of the first fingerprint and the second fingerprint is successfully verified, the electronic device logs in to an operating system, and when the first fingerprint and the second fingerprint are successfully verified at the same time, and the first fingerprint is different from the second fingerprint, the electronic device executes an application.

### CROSS REFERENCE TO RELATED APPLICATION

This application claims the priority benefit of U.S. provisional application Ser. No. 62/663,226, filed on Apr. 26, 2018. The entirety of the above-mentioned patent application is hereby incorporated by reference herein and made a part of specification

### BACKGROUND

### Technical Field

The invention relates to an electronic device and particularly relates to an electronic device with a fingerprint verification function and an operation method thereof.

### Description of Related Art

In recent years, electronic devices have become indispensable technological products in modern life. Since electronic devices are closely related to the life experiences of modern people, electronic devices often require verification to enter an operating system during a login process. Moreover, a variety of applications are installed in the electronic device to provide different functions, where some of the applications have issues in account binding so that a user probably has to go through multiple verification levels to start the applications. Therefore, how to provide an electronic device capable of simplifying user's operation steps and having account verification security has become a problem to be overcome.

### SUMMARY

The invention provides an electronic device with a fingerprint verification function and an operation method thereof, which can determine the operation function of the electronic device according to the number of fingerprint verifications of the user, and improve the convenience of the user operation and the security of the identity authentication.

An embodiment of the invention provides an electronic device with a fingerprint verification function, which includes a first fingerprint sensor and a second fingerprint sensor. The first fingerprint sensor is configured to verify a first fingerprint. The second fingerprint sensor is configured to verify a second fingerprint. When one of the first fingerprint and the second fingerprint is successfully verified, the electronic device logs in to an operating system, and when the first fingerprint and the second fingerprint are successfully verified at the same time, and the first fingerprint is different from the second fingerprint, the electronic device executes an application.

An embodiment of the invention provides an operation method for an electronic device with a fingerprint verification function. The operation method includes the following steps: sensing a first fingerprint through a first fingerprint sensor and logging in to an operating system when the first fingerprint is successfully verified; sensing the first fingerprint and a second fingerprint through the first fingerprint sensor and a second fingerprint sensor at the same time, wherein the first fingerprint is different from the second fingerprint and executing an application when both of the first fingerprint and the second fingerprint are successfully verified.

Based on the above description, the electronic device and the operation method thereof of the invention have the fingerprint verification function, the operating system is logged in by verifying the first fingerprint, and the application is executed by simultaneously identifying the first fingerprint and the second fingerprint.

To make the aforementioned more comprehensible, several embodiments accompanied with drawings are described in detail as follows.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a schematic diagram of an electronic device according to an embodiment of the invention.

FIG. 2 is a block diagram of an electronic device according to an embodiment of the invention.

FIG. 3 is a flowchart illustrating an operation method of an electronic device with a fingerprint verification function according to an embodiment of the invention.

FIG. 4 is a schematic diagram of an application executed by an electronic device according to an embodiment of the invention.

FIG. 5 is a schematic diagram of recognition signals of a first fingerprint and a second fingerprint according to an embodiment of the invention.

### DESCRIPTION OF THE EMBODIMENTS

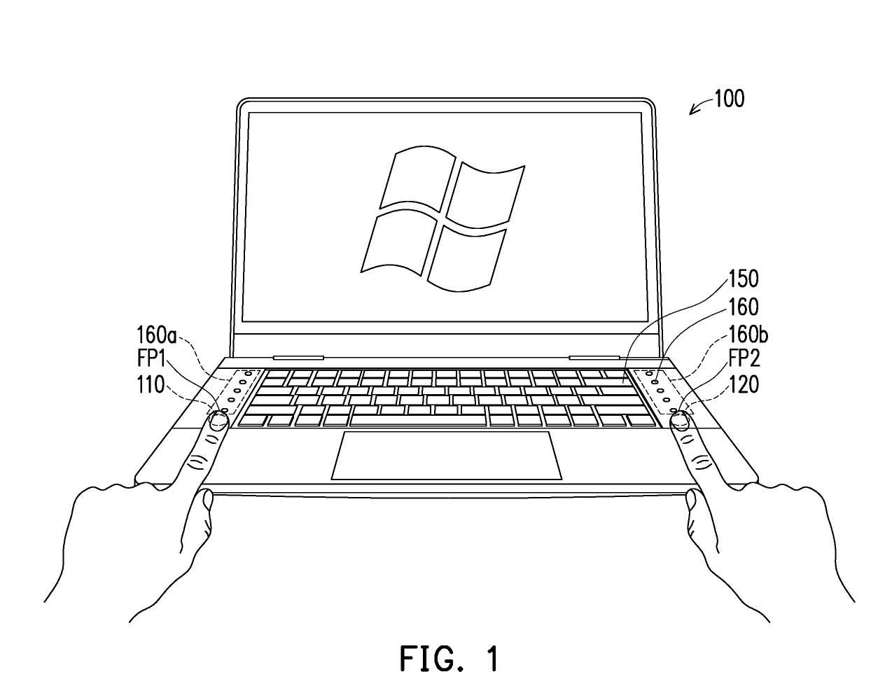

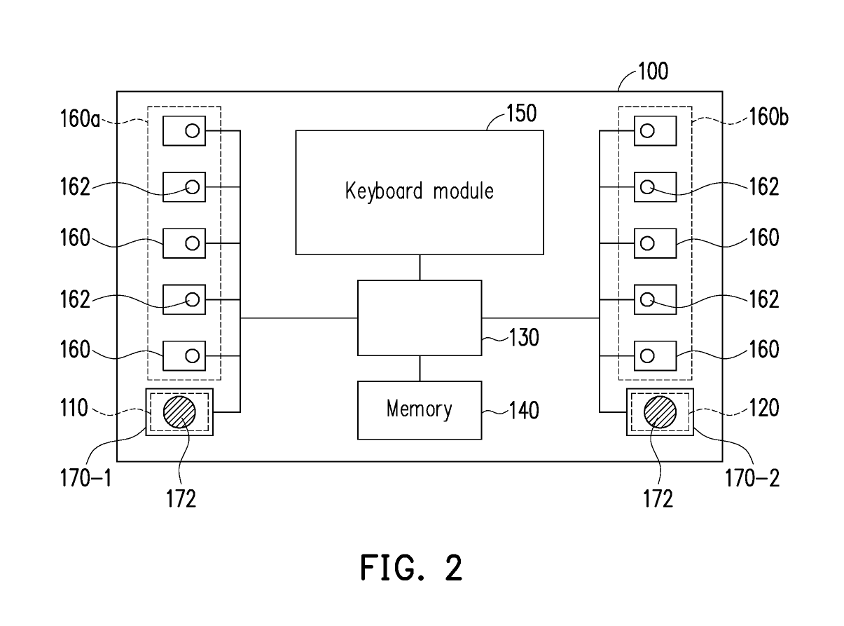

FIG. 1 is a schematic diagram of an electronic device according to an embodiment of the invention. FIG. 2 is a block diagram of an electronic device according to an embodiment of the invention. Referring to FIG. 1 and FIG. 2, the electronic device 100 is, for example, a notebook computer, but the invention does not limit the type of the electronic device 100. In other embodiments, the electronic device 100 may be a smartphone, a tablet personal computer or a personal computer, etc. The electronic device 100 at least includes a first fingerprint sensor 110 and a second fingerprint sensor 120. The first fingerprint sensor 110 and the second fingerprint sensor 120 may verify whether the user's fingerprints have complied with registered fingerprints and if yes, it represents that the verification is successful.

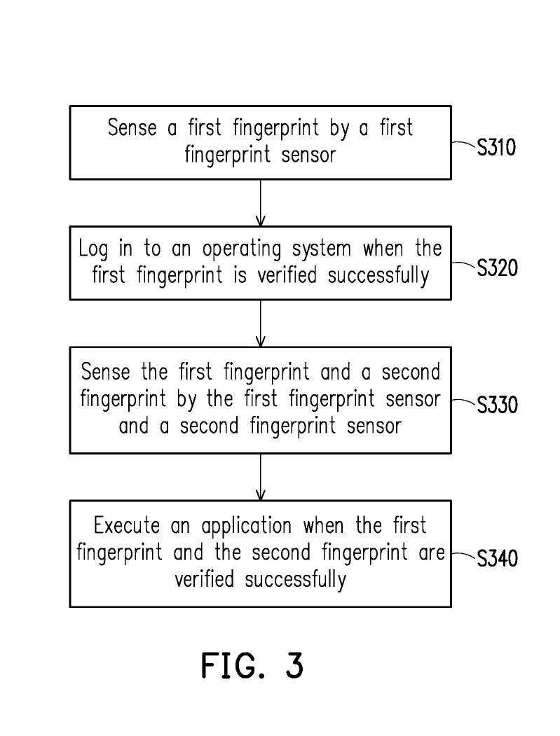

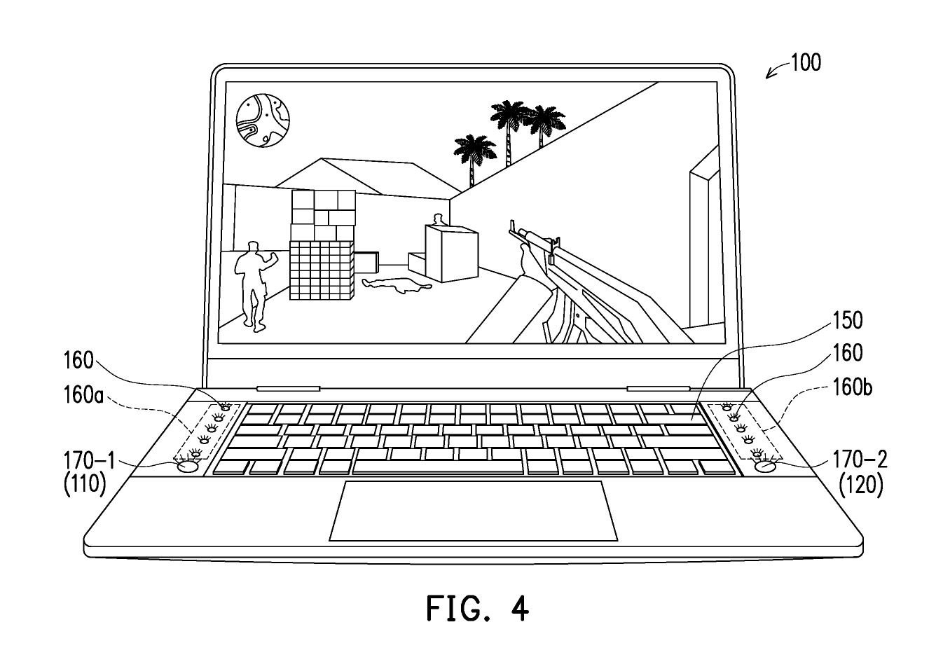

FIG. 3 is a flowchart illustrating an operation method of an electronic device with a fingerprint verification function according to an embodiment of the invention, and FIG. 4 is a schematic diagram of an application executed by an electronic device according to an embodiment of the invention. The operation method of FIG. 3 is at least adapted to the electronic device 100 of FIG. 1, FIG. 2 and FIG. 4, but the invention is not limited to that. Details of the operation method of the electronic device 100 of the invention are described below with reference of FIG. 1, FIG. 2 and FIG. 4.

In step S310 to step S320, after the electronic device 100 is turned on, a user may perform verification through one of the first fingerprint sensor 110 and the second fingerprint sensor 120 to log in to an operating system (OS). In step S310, the electronic device 100 senses a first fingerprint FP1 (for example, an index finger of a left hand) of the user through the first fingerprint sensor 110. In step S320, when the first fingerprint FP1 has complied with a registered fingerprint, it represents that the first fingerprint FP1 is verified successfully and the electronic device 100 identifies the user's identification, the electronic device 100 may log in to an operating system (referring to an operating system image displayed by the electronic device 100 of FIG. 1). The operating system of the electronic device 100 is, for example, Microsoft Windows operating system, Linux operating system, Android system, or iOS system, which is not limited by the invention.

Then, in step S330, the electronic device 100 simultaneously senses the first fingerprint FP1 and a second fingerprint FP2 through the first fingerprint sensor 110 and the second fingerprint sensor 120, where the first fingerprint FP1 and the second fingerprint FP2 are different fingerprints. Namely, the user simultaneously places two fingers on the first fingerprint sensor 110 and the second fingerprint sensor 120. For example, the user places the index finger of the left hand (the first fingerprint FP1) on the first fingerprint sensor 110 and the index finger of a right hand (the second fingerprint FP2) on the second fingerprint sensor 120 at the same time. Finally, in step S340, when the first fingerprint FP1 and the second fingerprint FP2 have complied with the registered fingerprints, it represents that the first fingerprint FP1 and the second fingerprint FP2 are both verified successfully, and the electronic device 100 may correspondingly execute an application. The above application may be a video game, audio-visual playing software, a computing software, an engineering software, etc., which is not limited by the invention (referring to a game image displayed by the electronic device 100 of FIG. 4).

Further, the activated application may be an application requiring account verification for execution. For example, the application is online game software. During the process of the electronic device 100 launching the online game software, the user has verified the identity through the first fingerprint FP1 and the second fingerprint FP2 to replace the traditional authentication process that requires manual input of the account and password. In this way, the user may complete the two steps of game startup and account identification at the same time by verifying two fingerprints at the same time, which significantly simplifies the process and is more convenient for the user. Besides, through the dual fingerprint verification function, the security of the user's identity verification is further improved, and it ensures the protection of the user login.

Notably, the first fingerprint FP1 used for logging in to the operating system and the first fingerprint FP1 in the two fingerprints used for verifying the account of the application may be the same or different.

Other details of the embodiment are introduced below. The electronic device 100 further includes a processor 130, a memory 140, a keyboard module 150, and at least one touch key. In FIG. 4, the application started through the dual fingerprint verification is a game program, and the touch keys are, for example, ten touch keys 160.

To be specific, the processor 130 is coupled to the first fingerprint sensor 110, the second fingerprint sensor 120, the memory 140, the keyboard module 150 and the touch keys 160, and is used to perform various types of operations required by the electronic device 100. The processor 130 is, for example, a Central Processing Unit (CPU), a Graphics Processing Unit (GPU) or a programmable general purpose or specific purpose microprocessor, a Micro Control Unit (MCU), a Digital Signal Processor (DSP), a programmable controller, an Application Specific Integrated Circuit (ASIC) or other similar device or a combination of the above devices, which is not limited by the invention.

The memory 140 is used for storing various programs and data required for operations of the electronic device 100. Particularly, the memory may store an operating system, multiple applications, and registered fingerprints. The memory 140 is, for example, a stationary or mobile Random Access Memory (RAM), a Read-Only Memory (ROM), a flash memory, a Hard Disk Drive (HDD), a Solid State Drive (SSD) or a similar element or a combination of the above elements, which is not limited by the invention.

After the electronic device 100 is booted and then logged into the operating system, the processor 130 operates in a first power mode. However, when the electronic device 100 selects to execute the game program, the processor 130 may switch from the first power mode to a second power mode to provide a better experience effect, wherein performances of the first power mode and the second power mode are different. For example, the first power mode may be a general mode or a power-saving mode, and the second power mode may be a high performance mode. In the embodiment, the electronic device 100 may increase the operating frequency of the processor 130 to improve the performance, or switch a graphics processor (GPU) (for example, to switch from an integrated graphics card on a motherboard to a dedicated graphics card), etc. The present invention does not limit implementations of how to improve the performance of the electronic device 100.

In the embodiment, the touch keys 160 may be divided into a first key group 160a and a second key group 160b, where the first key group 160a and the second key group 160b are respectively located on opposite sides of the keyboard module 150. The first fingerprint sensor 110 and the first key group 160a are disposed on the same side of the keyboard module 150, and the second fingerprint sensor 120 and the second key group 160b are disposed on the other side of the keyboard module 150. The first fingerprint sensor 110 and the second fingerprint sensor 120 are respectively located below the first key group 160a and the second key group 160b, i.e., located at positions closer to the user than the first key group 160a and the second key group 160b.

It should be noted that in some other embodiments, if the electronic device 100 is a mobile phone or a hand-held video game console equipping with a touch input module (for example, a touch screen or a touch panel). The first key group 160a and the second key group 160b may be respectively disposed on opposite sides of the touch input module, and the first fingerprint sensor 110 and the second fingerprint sensor 120 are correspondingly disposed below the first key group 160a and the second key group 160b. In some other embodiments, the electronic device may have both of a keyboard module and a touch input module, and a person skilled in the art may select different configurations of the touch key and the first fingerprint sensor and the second fingerprint sensor according to an actual requirement, which is not limited by the invention.

The touch keys 160 are enabled only when the application has been executed. Namely, when the user operates under an interface of the operating system, the touch keys 160 are disabled. After the user passes the dual fingerprint verification process at the same time, the electronic device 100 choose to execute the game program, and the touch keys 160 are enabled for the corresponding game. The user may assign functions to the touch keys 160 as keyboard shortcuts in the game. In this way, it is convenient for the user to play the game.

Besides, each of the touch keys 160 may include a light-emitting element 162, for example, a Light-Emitting Diode (LED). When the touch keys 160 are enabled, the light-emitting elements 162 light up. In this way, when the touch keys 160 are disabled, the touch keys 160 look invisible in an appearance of the electronic device 100, but when the touch keys 160 are enabled, the light-emitting elements 162 light up and the user may clearly see marks of the touch keys 160, which increases aesthetics in use.

In the embodiment, the first fingerprint sensor 110 and the second fingerprint sensor 120 are respectively integrated into a function switching key 170-1 and a function switching key 170-2. Besides the first fingerprint sensor 110 and the second fingerprint sensor 120, the function switching keys 170-1 and 170-2 further include switching elements 172. The user may touch the function switching keys 170-1 and 170-2 to perform fingerprint recognition or pressing operations. The user may press the function switching keys 170-1 and 170-2 to switch between interfaces of the operating system and the application.

The switching element 172 is, for example, a thin-film switch or a micro switch or other types of switching elements. In the embodiment of FIG. 2, the first fingerprint sensor 110, the second fingerprint sensor 120 and the corresponding switching element 172 are in a stacked configuration, but the configuration of the fingerprint sensors and the switching element 172 is not limited by the invention, which may be adjusted by a person skilled in the art according to a design or actual requirement.

When the user wants to quit the game program, the user may press at least one of the function switching key 170-1 or 170-2 to return to the interface of the operating system. In an embodiment, the electronic device 100 may also execute the application by pressing the function switching key 170-1 or 170-2 by the user, and meanwhile use the first fingerprint sensor 110 and the second fingerprint sensor 120 to sense the first fingerprint FP1 and the second fingerprint FP2 to complete the identity verification.

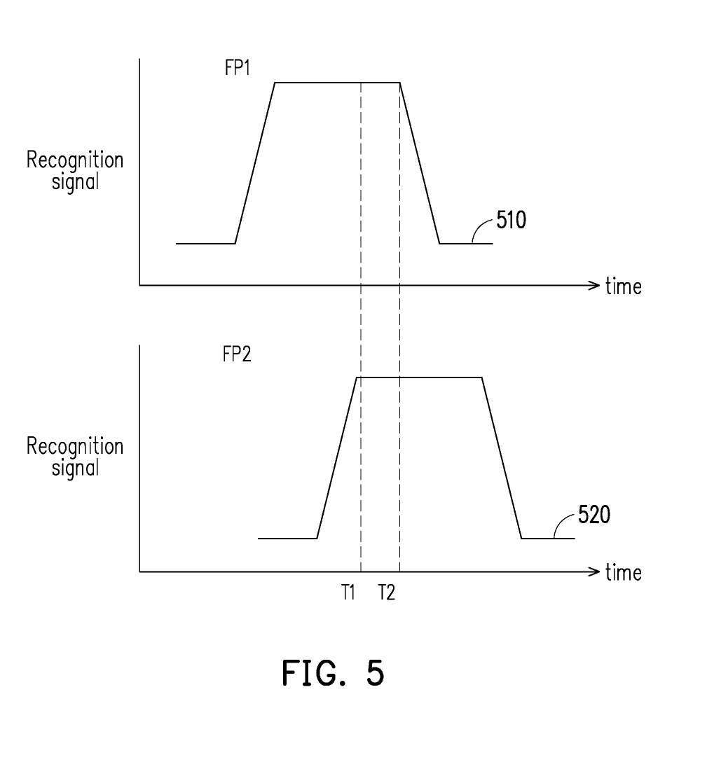

FIG. 5 is a schematic diagram of recognition signals of a first fingerprint and a second fingerprint according to an embodiment of the invention. In the embodiment, when the user wants to execute a payment function or log in to an account of the application, the electronic device 100 may require to simultaneously verify the first fingerprint FP1 and the second fingerprint FP2, and the first fingerprint FP1 is different from the second fingerprint FP2. In other words, when the user wants to require identity verification, the electronic device 100 may need the user to place fingers respectively on the first fingerprint sensor 110 and the second fingerprint sensor 120 to obtain two recognition signals. Referring to FIG. 5, an upper curve 510 is the recognition signal of the first fingerprint FP1 sensed by the first fingerprint sensor 110, and a lower curve 520 is the recognition signal of the second fingerprint FP2 sensed by the second fingerprint sensor 120.

The processor 130 receives the recognition signal 510 and the recognition signal 520 from the first fingerprint sensor 110 and the second fingerprint sensor 120 and determines whether the first fingerprint FP1 and the second fingerprint FP2 have complied with the registered fingerprints stored in the memory 140 according to the recognition signal 510 and the recognition signal 520. Moreover, the processor 130 may further obtain a sensing time from the recognition signal 510 and the recognition signal 520. In the embodiment, after the first fingerprint FP1 and the second fingerprint FP2 have complied with the registered fingerprints and the processor 130 has determined that the sensing time of the recognition signal 510 and the sensing time of the recognition signal 520 are overlapped between a time point T1 and a time point T2, the processor 130 determines that the first fingerprint FP1 and the second fingerprint FP2 are verified successfully at the same time, and then executes a predetermined application or a payment function.

If the sensing time of the recognition signal 510 and the sensing time of the recognition signal 520 are not overlapped, even if the first fingerprint FP1 and the second fingerprint FP2 have complied with the registered fingerprints, the processor 130 does not execute the application or the payment function. Alternatively, one of the first fingerprint FP1 and the second fingerprint FP2 does not comply with the registered fingerprint, the application or the payment function is not activated.

According to the approach as mentioned above, the security of user verification is improved, and since the user needs to consciously verify the fingerprints of two fingers at the same time, it avoids from a situation that the user activates the application or performs accidental payment mistakenly.

In summary, embodiments of the invention provide an electronic device with a fingerprint verification function and an operation method thereof. The electronic device has at least two fingerprint sensors to simultaneously recognize the two fingers of the user to perform the identity verification. When the user only verifies one fingerprint at a time, the electronic device may execute a login operation of the operating system, and when the user confirms two fingerprints at a time, the electronic device may perform the predetermined application. Moreover, in some embodiments, the electronic device may further adjust the performance of the processor according to the application, and enable the touch keys set for the application. In this way, the electronic device and the operation method thereof of the invention may simplify the user's steps to complete activating the application and the verification operation at the same time, and through the dual fingerprint verification, security is improved, and mistaken touch is prevented, and the user's experience of executing the application is optimized.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. An electronic device with a fingerprint verification function, comprising:
a first fingerprint sensor, configured to verify a first fingerprint; and
a second fingerprint sensor, configured to verify a second fingerprint,
wherein when one of the first fingerprint and the second fingerprint is successfully verified, the electronic device logs in to an operating system, and when the first fingerprint and the second fingerprint are successfully verified at the same time, and the first fingerprint is different from the second fingerprint, the electronic device executes an application.

2. The electronic device as claimed in claim 1, further comprising:
a processor, wherein when the electronic device executes the application, the processor switches from a first power mode to a second power mode, wherein performances of the first power mode and the second power mode are different.

3. The electronic device as claimed in claim 1, further comprising:
at least one touch key, wherein the at least one touch key is enabled when the application is executed.

4. The electronic device as claimed in claim 3, wherein the at least one touch key comprises a light-emitting element, and when the at least one touch key is enabled, the light-emitting element lights up.

5. The electronic device as claimed in claim 3, further comprising:
a keyboard module or a touch input module,
wherein the at least one touch key includes a plurality of touch keys, and the touch keys are divided into a first key group and a second key group, wherein the first key group and the second key group are respectively located on opposite sides of the keyboard module or the touch input module.

6. The electronic device as claimed in claim 5, wherein the first fingerprint sensor and the first key group are disposed on a same side of the keyboard module or the touch input module, the second fingerprint sensor and the second key group are disposed on the other side of the keyboard module or the touch input module, and the first fingerprint sensor and the second fingerprint sensor are located at positions closer to a user than the first key group and the second key group.

7. The electronic device as claimed in claim 3, wherein the at least one touch key is assigned a function by a user to serve as a keyboard shortcut when the application is executed.

8. The electronic device as claimed in claim 1, further comprising:
a function switching key, comprising the first fingerprint sensor or the second fingerprint sensor and a switching element, wherein a user presses the function switching key to switch between interfaces of the operating system and the application.

9. The electronic device as claimed in claim 1, wherein the electronic device verifies the first fingerprint and the second fingerprint at the same time so as to let a user execute a payment function or log in to an account of the application.

10. An operation method for an electronic device with a fingerprint verification function, comprising:
sensing a first fingerprint through a first fingerprint sensor, and logging in to an operating system when the first fingerprint is successfully verified;
sensing the first fingerprint and a second fingerprint through the first fingerprint sensor and a second fingerprint sensor at the same time, wherein the first fingerprint is different from the second fingerprint; and
executing an application when both of the first fingerprint and the second fingerprint are successfully verified.

11. The operation method as claimed in claim 10, wherein when the application is executed, a processor of the electronic device switches from a first power mode to a second power mode, wherein performances of the first power mode and the second power mode are different.

12. The operation method as claimed in claim 10, wherein when the application is executed, at least one touch key is enabled.

13. The operation method as claimed in claim 12, wherein when the at least one touch key is enabled, a light-emitting element in the at least one touch key lights up.

14. The operation method as claimed in claim 12, further comprising:
assigning a function to the at least one touch key so that the at least one touch key serves as a keyboard shortcut when the application is executed.

15. The operation method as claimed in claim 10, further comprising:
executing a payment function or logging in to an account of the application by verifying the first fingerprint and the second fingerprint at the same time.
